(19) United States
(12) Patent Application Publication
(10) Pub. No.: US 2026/0121308 A1
(43) Pub. Date: Apr. 30, 2026

(54) CONNECTION STRUCTURE AND ASSEMBLY

(71) Applicant: Yazaki Corporation, Tokyo (JP)

(72) Inventors: Takahiko Katsuramaki, Makinohara-shi (JP); Hajime Kato, Makinohara-shi (JP); Syoichi Nomura, Makinohara-shi (JP)

(73) Assignee: Yazaki Corporation, Tokyo (JP)

(21) Appl. No.: 19/009,053

(22) Filed: Jan. 3, 2025

(30) Foreign Application Priority Data
Jan. 10, 2024 (JP) 2024-001906

(51) Int. Cl. H01R 4/30

(52) U.S. Cl. CPC H01R 4/308

(57) ABSTRACT

A connection structure according to an embodiment includes: a first conductor including a first bus bar, the first bus bar having a first contacted surface and including a first stud protruding from the first contacted surface; a second conductor provided at a position away from the first conductor; a third conductor configured to be brought into contact with the first contacted surface and the first stud, the third conductor being movable with respect to the first conductor and the second conductor in a moving direction intersecting the first contacted surface; and a biasing portion capable of biasing the third conductor toward the first contacted surface and capable of relaying conduction between the second conductor and the third conductor.

### BACKGROUND OF THE INVENTION

### Field of the Invention

Embodiments of the present invention relate to a connection structure and an assembly.

This application claims priority to Japanese Patent Application No. 2024-001906 filed in Japan on Jan. 10, 2024, the contents of which are incorporated herein by reference.

### Description of Related Art

It is widely known that a battery pack as a power supply source is connected to a device. For example, Japanese Unexamined Patent Application, First Publication No. 2018-144524 discloses a battery module that is connected to a fuse contactor unit of an electric vehicle.

### SUMMARY OF THE INVENTION

In the assembly disclosed in Japanese Unexamined Patent Application, First Publication No. 2018-144524, a power supply-side male terminal provided in a battery module is directly attached to and detached from each of a plurality of power reception-side female terminals connected to a fuse contactor unit. However, in such a connection structure including terminals, the contact pressure between conductors of both units cannot be secured in some cases.

An embodiment of the present invention provides a connection structure and an assembly that easily secure the contact pressure of a conductor.

A connection structure according to an embodiment of the present invention includes: a first conductor including a first bus bar, the first bus bar having a first contacted surface and including a first stud protruding from the first contacted surface; a second conductor provided at a position away from the first conductor; a third conductor configured to be brought into contact with the first contacted surface and the first stud, the third conductor being movable with respect to the first conductor and the second conductor in a moving direction intersecting the first contacted surface; and a biasing portion capable of biasing the third conductor toward the first contacted surface and capable of relaying conduction between the second conductor and the third conductor.

According to the connection structure and the assembly of an embodiment of the present invention, it is easy to secure the contact pressure of a conductor.

### BRIEF DESCRIPTION OF THE DRAWINGS

FIG. 1 is a front view of an assembly before fastening according to each embodiment.

FIG. 2 is an enlarged view of a portion II in FIG. 1 of the assembly before fastening according to the first embodiment.

FIG. 3 is a cross-sectional view of the assembly before fastening according to the first embodiment taken along line III-III in FIG. 1.

FIG. 4 is a bottom view of a third conductor and a housing according to the first embodiment.

FIG. 5 is a cross-sectional view of the assembly after fastening according to the first embodiment taken along line III-III in FIG. 1.

FIG. 6 is an explanatory view of a current path in the assembly after fastening according to the first embodiment.

FIG. 7 is a cross-sectional view of an assembly before fastening according to a modification of the first embodiment taken along line VII-VII in FIG. 1.

FIG. 8 is a bottom view of a third conductor and a housing according to a modification of the first embodiment.

FIG. 9 is a cross-sectional view of an assembly before fastening according to a second embodiment taken along line III-III of FIG. 1.

FIG. 10 is a cross-sectional view of the assembly after fastening according to the second embodiment taken along line III-III in FIG. 1.

FIG. 11 is a front view of an assembly before fastening according to a modification of each embodiment.

### DETAILED DESCRIPTION OF THE INVENTION

### First Embodiment

Hereinafter, a connection structure and an assembly according to an embodiment will be described with reference to the drawings.

### (Constitution of Assembly)

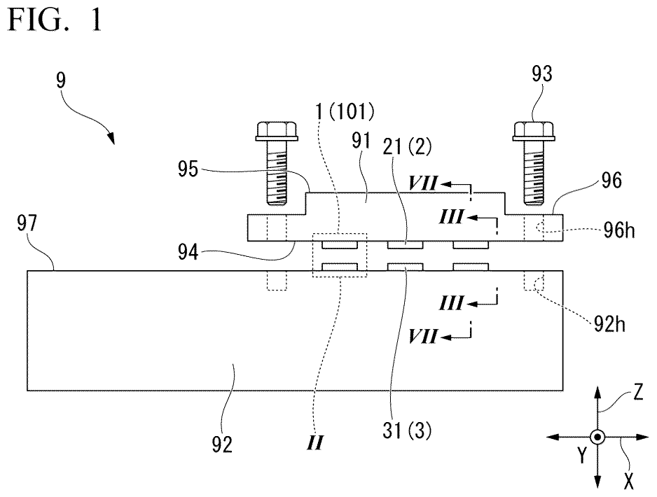

As illustrated in FIG. 1, an assembly 9 of the present embodiment includes a plurality of connection structures 1, a device 91, a battery pack 92, and a fastener 93. The device 91 and the battery pack 92 are fastened by the fastener 93, whereby the assembly 9 is unitized. For example, the assembly 9 may be mounted on a mobility unit such as an electric vehicle.

### (Device)

The device 91 receives and transmits power from and to the battery pack 92. For example, the device 91 may be a high-voltage device such as a high-voltage junction box (J/B), an on-board charger (OBC), or a DC-DC converter. The device 91 has a second installation surface 94 on a side facing the battery pack 92. The device 91 has a main surface 95 on the side opposite to the side facing the battery pack 92.

Hereinafter, a direction parallel to the direction in which the second installation surface 94 faces is referred to as a Z direction. Hereinafter, the Z direction is also referred to as a “moving direction”. Further, directions intersecting each other in a plane facing the Z direction are defined as an X direction and a Y direction. For example, the X direction, the Y direction, and the Z direction may be directions orthogonal to each other. For example, the Z direction may be the “vertical direction”. For example, the second installation surface 94 may be a plane facing downward. For example, the main surface 95 may be a plane facing upward. For example, the second installation surface 94 and the main surface 95 may be planes parallel to each other.

Each of the second installation surface 94 and the main surface 95 is an insulating surface made of an insulator material. For example, each of the second installation surface 94 and the main surface 95 may be an insulating housing, a partially insulating cover, or the like.

The device 91 has flanges 96 protruding on both sides in the X direction. The flange 96 has a plurality of through holes 96h extending in the Z direction. The device 91 and the battery pack 92 are fastened together by the fastener 93 inserted into each through hole 96h.

### (Constitution of Battery Pack)

The battery pack 92 includes a plurality of battery cells. The battery pack 92 has a first installation surface 97 on a side facing the device 91. The first installation surface 97 faces the second installation surface 94. For example, the first installation surface 97 may be a plane facing upward.

The battery pack 92 has a screw hole 92h in the first installation surface 97. The fastener 93 inserted into the through hole 96h is tightened into the screw hole 92h.

The first installation surface 97 is an insulating surface made of an insulator material. For example, the first installation surface 97 may be an insulating housing, a partially insulating cover, or the like.

### (Constitution of Connection Structure)

The plurality of connection structures 1 are structures for electrically connecting the device 91 and the battery pack 92. The plurality of connection structures 1 are provided side by side in the X direction. Each connection structure 1 is provided between the second installation surface 94 and the first installation surface 97.

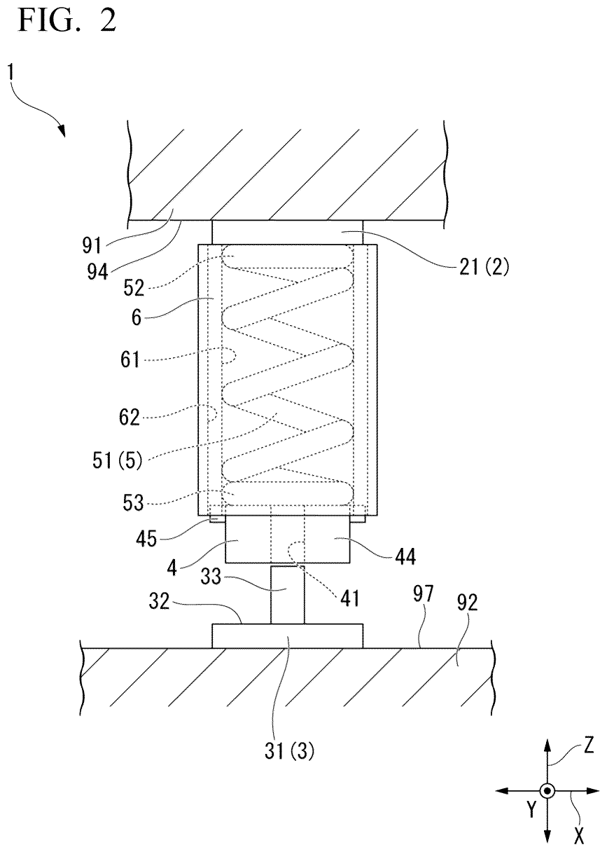

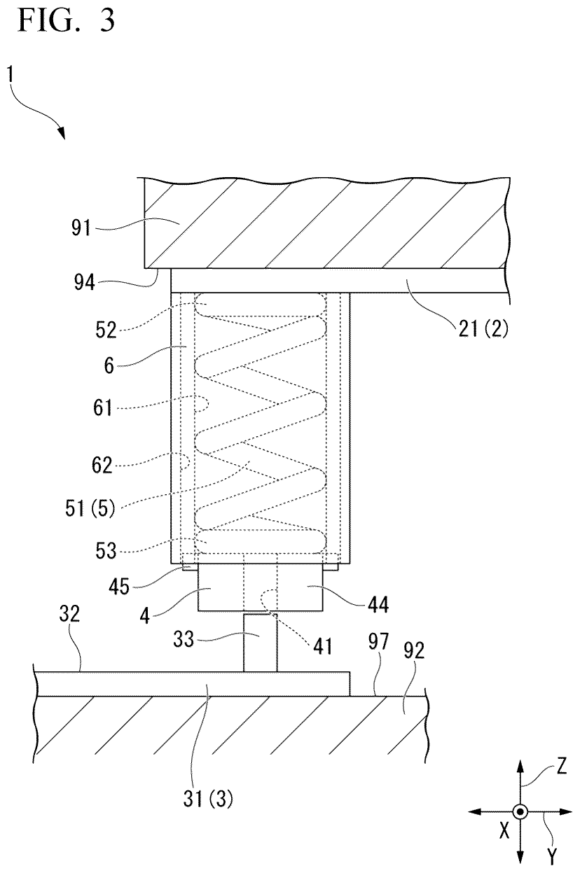

As illustrated in FIGS. 2 and 3, each connection structure 1 includes a device conductor 2 (second conductor), a battery conductor 3 (first conductor), a third conductor 4, a biasing portion 5, and a housing 6. Hereinafter, “conduction” means that a path through which a current flows is formed.

### (Constitution of Battery Conductor)

The battery conductor 3 is electrically connected to an electrode included in the battery pack 92. The battery conductor 3 includes a battery bus bar 31 (first bus bar).

### (Constitution of Battery Bus Bar)

The battery bus bar 31 extends in the Y direction to immediately below the third conductor 4 while being in contact with the first installation surface 97.

The battery bus bar 31 has a first contacted surface 32 on a side facing the third conductor 4. The first contacted surface 32 is a flat surface.

The battery bus bar 31 includes a first stud 33. The first stud 33 protrudes in the Z direction from the first contacted surface 32 toward the third conductor 4. For example, the first stud 33 may have a columnar shape.

For example, the battery bus bar 31 may have a constant thickness. For example, each of the battery bus bars 31 may be an integral flat plate having a pair of plate surfaces facing the Z direction and extending in the Y direction. The battery bus bar 31 is formed of a conductive material such as metal.

### (Constitution of Device Conductor)

The device conductor 2 is electrically connected to the device 91. The device conductor 2 includes a device bus bar 21 (second bus bar). The device conductor 2 is provided at a position away from the battery conductor 3.

### (Constitution of Device Bus Bar)

The device bus bar 21 is electrically connected to an electrode included in the device 91. For example, the device bus bar 21 may extend in the Y direction while being in contact with the second installation surface 94, and may be in contact with an upper surface of the housing 6 at the extending end. For example, the device bus bar 21 may have a constant thickness. For example, the device bus bar 21 may be an integral flat plate having a pair of plate surfaces facing the Z direction and extending in the Y direction. The device bus bar 21 is formed of a conductive material such as metal.

### (Constitution of Housing)

The housing 6 accommodates the biasing portion 5. The housing 6 has an inner peripheral surface 61 extending in the Z direction. For example, the housing 6 may have a cylindrical shape.

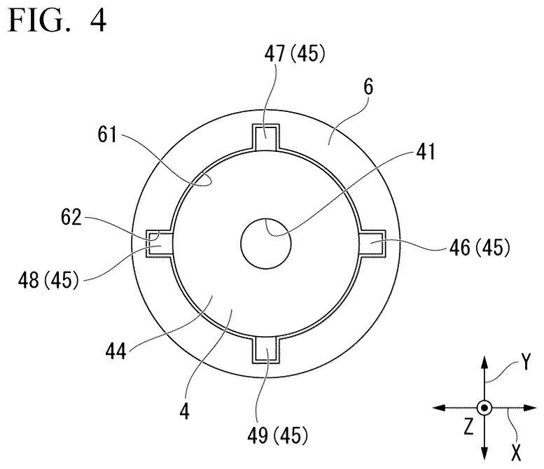

As illustrated in FIG. 4, for example, the housing 6 may have a plurality of grooves 62 recessed radially outward of the housing 6 from the inner peripheral surface 61. For example, the housing 6 may be formed of a conductive material such as metal, and may be electrically connected to a lower surface of the device bus bar 21 at the upper end of the housing 6. For example, the plurality of grooves 62 may be arranged at four positions on both sides in the X direction and both sides in the Y direction on the inner peripheral surface 61.

### (Constitution of Third Conductor)

The third conductor 4 can come into contact with the first contacted surface 32 so as to be electrically connected to the first contacted surface 32. The third conductor 4 can come into contact with the first stud 33 so as to be electrically connected to the first stud 33. The third conductor 4 is movable in the Z direction with respect to the device conductor 2 and the battery conductor 3. The third conductor 4 is movable along the inner peripheral surface 61. For example, third conductor 4 may have a first fitting portion 41. For example, the third conductor 4 may include a columnar body 44 and a plurality of protrusions 45 protruding from an upper portion of the body 44 in the radial direction of the body 44.

When the first stud 33 is inserted into the first fitting portion 41, the first stud 33 can fit thereinto. The first fitting portion 41 can come into contact with the first stud 33 so as to be electrically connected to the first stud 33. For example, the first fitting portion 41 may be a circular hole penetrating in the Z direction. Furthermore, the first fitting portion 41 may have, as such a circular hole, a circular hole having a diameter slightly larger than the outer diameter of the columnar first stud 33 to such an extent that the first stud 33 can be press-fitted. The third conductor 4 is formed of a conductive material such as metal.

A lower surface of the body 44 can come into contact with the first contacted surface 32 so as to be electrically connected to the first contacted surface 32. For example, the lower surface of the body 44 may be a flat surface. For example, the outer diameter of the body 44 may be slightly smaller than the diameter of the inner peripheral surface 61 to such an extent that the third conductor 4 can move along the inner peripheral surface 61. For example, the body 44 may be coaxial with the housing 6. For example, the first fitting portion 41 may be coaxial with and penetrate the body 44.

The plurality of protrusions 45 are arranged at equal intervals in the circumferential direction of the body 44. For example, the plurality of protrusions 45 may include a first protrusion 46, a second protrusion 47, a third protrusion 48, and a fourth protrusion 49. The first protrusion 46 protrudes to one side in the X direction from one side in the X direction of the body 44. The second protrusion 47 protrudes to one side in the Y direction from one side in the Y direction of the body 44. The third protrusion 48 protrudes to the other side in the X direction from the other side in the X direction of the body 44. The fourth protrusion 49 protrudes to the other side in the Y direction from the other side in the Y direction of the body 44. Note that the plurality of grooves 62 are provided at positions corresponding to the plurality of protrusions 45.

### (Constitution of Biasing Portion)

The biasing portion 5 can bias the third conductor 4 toward the first contacted surface 32. The biasing portion 5 can relay conduction between the device conductor 2 and the third conductor 4. The biasing portion 5 is elastically deformable in the Z direction.

As illustrated in FIGS. 2 and 3, for example, the biasing portion 5 may include a coil spring 51. The coil spring 51 extends in the Z direction coaxially with the housing 6. The coil spring 51 has a first end 52 on the device conductor 2 side and a second end 53 on the third conductor 4 side. For example, the coil spring 51 may be electrically connected to the device conductor 2 by the first end 52 being fixed in contact with the lower surface of the device bus bar 21. For example, the coil spring 51 may be electrically connected to the third conductor 4 by the second end 53 being fixed in contact with the upper surface of the third conductor 4. The coil spring 51 is formed of a conductive material such as metal.

With such a constitution, the coil spring 51 can relay conduction between the device bus bar 21 and the third conductor 4. For example, the coil spring 51 may be contactable with the inner peripheral surface 61 of the housing 6 formed of a conductive material such as metal.

### (Constitution of Fastener)

The plurality of fasteners 93 fasten the device 91 and the battery pack 92. For example, each fastener 93 may be a bolt fastened to the screw hole 92h through the through hole 96h.

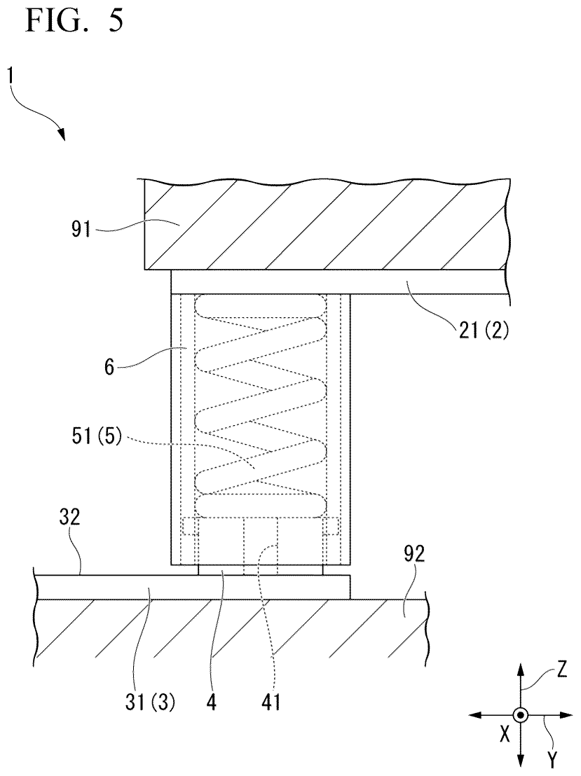

When the assembly 9 is assembled, for example, the device 91 is tightened to be fastened to the battery pack 92 with the fastener 93 such that the device 91 is brought close to the battery pack 92. With such fastening, as illustrated in FIG. 5, the third conductor 4 comes into contact with the first contacted surface 32 while the first stud 33 is fitted into the first fitting portion 41. When further tightened, the third conductor 4 receives a pressing force upward from the first contacted surface 32.

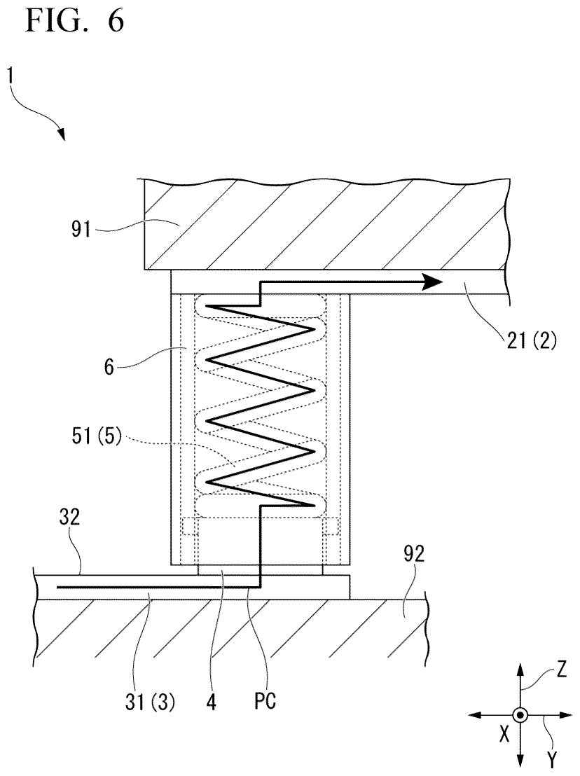

The third conductor 4 moves in the Z direction with respect to the device conductor 2 and the battery conductor 3, so that the third conductor 4 receiving the pressing force from the first contacted surface 32 elastically deforms the biasing portion 5. On the other hand, the elastically deformed biasing portion 5 exerts a biasing force directed toward the first contacted surface 32 on the third conductor 4. Due to the deformation and the biasing force, in the assembled assembly 9, the third conductor 4 comes into contact with the first contacted surface 32 while the biasing portion 5 absorbs the pressing force from the first contacted surface 32. In addition, the third conductor 4 comes into contact with the first stud 33 in the first fitting portion 41. Further, the biasing portion 5 relays conduction between the third conductor 4 in contact with the battery conductor 3 and the device conductor 2. As a result of the contact, for example, the connection structure 1 can electrically connect the device conductor 2 and the battery conductor 3 so that a current flows along a current path PC illustrated in FIG. 6.

### Operation and Effect

In the connection structure 1 of the present embodiment, with the constitution of the third conductor 4 and the biasing portion 5, the third conductor 4 can be brought into contact with the battery bus bar 31 while biasing the third conductor 4 in the moving direction. The third conductor 4 brought into contact in this manner can secure the contact pressure with the battery bus bar 31 while changing the position in the moving direction. With such an operation, the connection structure 1 can absorb manufacturing tolerance related to electrical connection between the device conductor 2 and the battery conductor 3, which is likely to occur at the time of assembling the device 91 and the battery pack 92. Therefore, the connection structure 1 of the present embodiment can easily secure the contact pressure between the device conductor 2 and the battery conductor 3.

For example, regarding a plurality of assemblies 9 of different lots, the assembly 9 can absorb tolerances related to a dimensional error between lots of various structures related to contact between the device conductor 2 and the battery conductor 3, a fastening pressure error, and the like. For example, in the assembly 9, a plurality of third conductors 4 across a plurality of connection structures 1 can be displaced in the vertical direction independently of each other. With such displacement, the assembly 9 can absorb a tolerance related to a dimensional error between the plurality of device bus bars 21, a dimensional error between the plurality of battery bus bars 31, and the like with respect to one assembly 9. For example, with respect to one assembly 9, the assembly 9 can absorb tolerance related to variation in contact pressure generated due to non-uniformity of fastening pressure, which is variation in contact pressure across the plurality of device conductors 2 and the plurality of battery conductors 3.

As a comparative example, assume that the structure of the assembly is a structure in which a connector is provided in a battery pack and a vehicle body-side connector and a battery-side connector are connected when the battery pack is attached to the vehicle body as in Japanese Unexamined Patent Application, First Publication No. 2018-144524. With such a structure of the comparative example, when there are multiple connection points, the fitting state of each connector cannot be checked and there may be a half-fitted connector, a very large insertion force may be required at the time of collective connection, or the component cost may be increased.

In contrast to this comparative example, the present embodiment has a structure in which the third conductor 4 can come into contact with the first contacted surface 32 and the first stud 33 while being biased toward the first contacted surface 32. With this structure, even when there are multiple connection points, it is easy to secure the contact pressure between each device conductor 2 and the associated battery conductor 3 while suppressing the fastening pressure and the number of components.

In particular, when the device 91 is a high-voltage device, the electrical connection between the device 91 and the battery pack 92 is electrical connection between bus bars in many parts, and thus it is effective to secure the contact pressure between the device conductor 2 and the battery conductor 3 as in the present embodiment.

According to an example of the connection structure 1 of the present embodiment, the third conductor 4 is movable along the inner peripheral surface 61 of the housing 6 accommodating the biasing portion 5. According to such a housing 6, the inclination of the third conductor 4 with respect to the first contacted surface 32 is curbed. Therefore, in the example of the connection structure 1 of the present embodiment, it is easy to secure the contact pressure between the device conductor 2 and the battery conductor 3.

According to the example of the connection structure 1 of the present embodiment, the coil spring 51 can relay conduction between the device conductor 2 and the third conductor 4. Therefore, since the coil spring 51 can secure conduction between the device conductor 2 and the third conductor 4 and can bias the third conductor 4, the structure of the biasing portion 5 can be simplified. An example of the connection structure 1 of the present embodiment is easy to manufacture.

According to an example of the connection structure 1 of the present embodiment, the first stud 33 is inserted into the first fitting portion 41. According to such a constitution, since the inclination of the third conductor 4 with respect to the first contacted surface 32 is curbed by the insertion into first fitting portion 41, the third conductor 4 and the first contacted surface 32 easily come into contact with each other. On the other hand, insertion into the first fitting portion 41 enables surface contact between the third conductor 4 and the first stud 33. Therefore, in the example of the connection structure 1 of the present embodiment, it is easy to secure electrical connectivity between the device conductor 2 and the battery conductor 3.

According to an example of the connection structure 1 of the present embodiment, the third conductor 4 includes the plurality of protrusions 45. According to such a constitution, a contact area between the third conductor 4 and the inner peripheral surface 61 of the housing 6 can be reduced. With such an operation, it is possible to reduce dynamic friction of the third conductor 4 with respect to the inner peripheral surface 61. Therefore, in the example of the connection structure 1 of the present embodiment, it is easy to secure the contact pressure between the device conductor 2 and the battery conductor 3.

### Modification

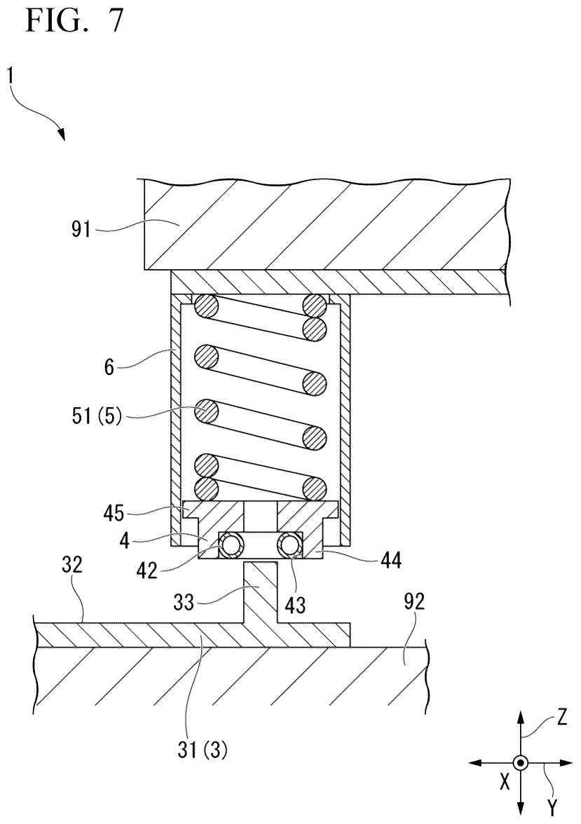

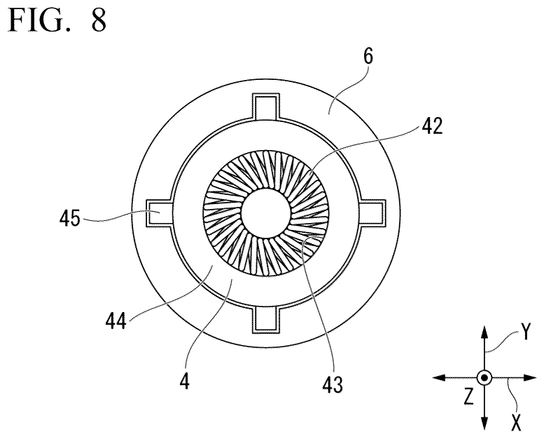

In an example of the connection structure 1 of the present embodiment, the first fitting portion 41 is configured so that the first stud 33 can be inserted thereinto. Note, however, that the third conductor 4 may be configured in any manner as long as the third conductor 4 can come into contact with the first stud 33. As a modification, as illustrated in FIGS. 7 and 8, a third conductor 4 may include an elastic conductor 42 instead of the first fitting portion 41. The elastic conductor 42 can come into contact with a first stud 33. The elastic conductor 42 is fitted into a recess 43 provided on a lower surface of a body 44. The elastic conductor 42 is in contact with the body 44 in the recess 43. The first stud 33 can be fitted to the elastic conductor 42. For example, the elastic conductor 42 may have an annular shape into which the first stud 33 can be fitted. For example, the elastic conductor 42 may be an annular diagonally wound coil spring. According to a connection structure 1 of this modification, the elastic conductor 42 secures conduction between the third conductor 4 and the first stud 33. According to the elastic conductor 42 of this modification, the electrical connectivity between the third conductor 4 and the first stud 33 can be improved. In addition, according to the elastic conductor 42 of this modification, the insertion force is reduced as compared with the case where the first stud 33 is press-fitted into the first fitting portion 41 as in the above-described embodiment.

In an example of the connection structure 1 of the present embodiment, the first end 52 is electrically connected to the device conductor 2 by being fixed in contact with the lower surface of the device bus bar 21. Note, however, that this constitution may be configured in any manner as long as electrical connection can be secured. As a modification, the first end 52 may be molded integrally with the device bus bar 21.

In an example of the connection structure 1 of the present embodiment, the second end 53 is electrically connected to the third conductor 4 by being fixed in contact with the upper surface of the third conductor 4. Note, however, that this constitution may be configured in any manner as long as electrical connection can be secured. As a modification, the second end 53 may be molded integrally with the third conductor 4.

In an example of the connection structure 1 of the present embodiment, the housing 6 is formed of a conductive material such as metal, and is electrically connected to the lower surface of the device bus bar 21 at the upper end of the housing 6. Note, however, that the housing 6 may be configured in any manner as long as the inclination of the third conductor 4 with respect to the first contacted surface 32 is curbed. As a modification, the housing 6 may be formed of an insulating material such as resin. As another modification, the housing 6 does not have to be electrically connected to the lower surface of the device bus bar 21 at the upper end of the housing 6. Note that on the other hand, unlike these modifications, if the housing 6 is configured as in the example of the connection structure 1 of the above-described embodiment, the contact between the coil spring 51 and the housing 6 can form a current path passing through the housing 6 in addition to the current path PC. If such a current path can be formed, the electrical resistance between the device 91 and the battery pack 92 can be reduced.

### Second Embodiment

Hereinafter, a connection structure of an embodiment will be described with reference to the drawings. A connection structure 101 of the present embodiment has a structure in which the structure between the device bus bar 21 and the coil spring 51 of the connection structure 1 is replaced with a structure similar to that between the battery bus bar 31 and the coil spring 51. Each constitution of the connection structure 101 has a constitution similar to those of the connection structure 1 of the first embodiment except for the following points, is similarly connected, and has a similar operation and effect.

### (Constitution of Connection Structure)

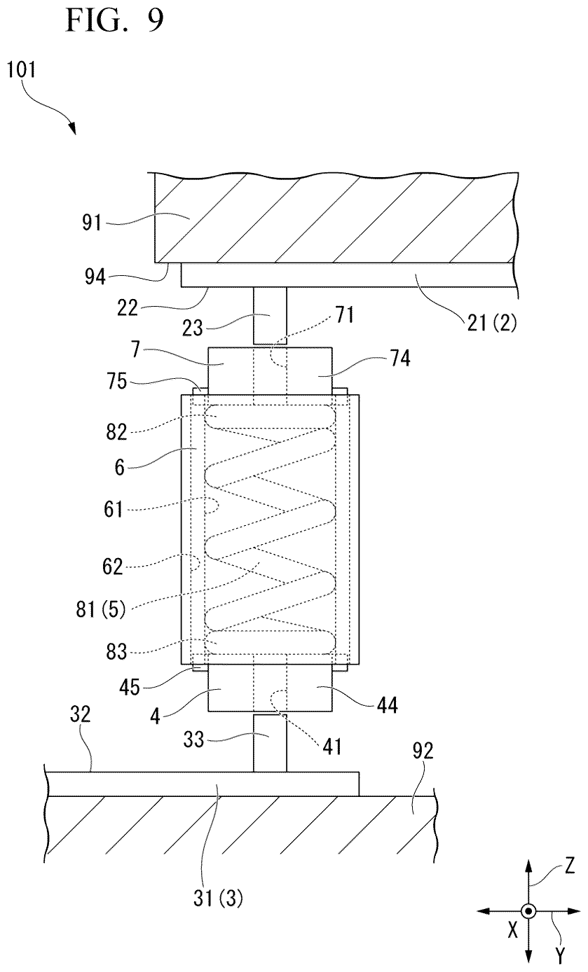

As illustrated in FIG. 9, the connection structure 101 includes a device conductor 2 (second conductor), a battery conductor 3 (first conductor), a third conductor 4, a biasing portion 5, a housing 6, and a fourth conductor 7.

### (Constitution of Device Conductor)

The device conductor 2 includes a device bus bar 21 (second bus bar). The device bus bar 21 has a second contacted surface 22 on a side facing the fourth conductor 7. The second contacted surface 22 is a flat surface. The device bus bar 21 includes a second stud 23. The second stud 23 protrudes in the Z direction from the second contacted surface 22 toward the fourth conductor 7. For example, the second stud 23 may have a columnar shape.

### (Constitution of Fourth Conductor)

The fourth conductor 7 can come into contact with the second contacted surface 22 so as to be electrically connected to the second contacted surface 22. The fourth conductor 7 can come into contact with the second stud 23 so as to be electrically connected to the second stud 23. The fourth conductor 7 is movable in the Z direction with respect to the device conductor 2 and the battery conductor 3. The fourth conductor 7 is movable along an inner peripheral surface 61. For example, the fourth conductor 7 may have a second fitting portion 71. For example, the fourth conductor 7 may include a columnar body 74 and a plurality of protrusions 75 protruding from a lower portion of the body 74 in the radial direction of the body 74.

The second stud 23 can be fitted into the second fitting portion 71. The second stud 23 is press-fitted into the second fitting portion 71. The second fitting portion 71 can come into contact with the second stud 23 so as to be electrically connected to the second stud 23. For example, the second fitting portion 71 may be a circular hole penetrating in the Z direction. Furthermore, the second fitting portion 71 may have, as such a circular hole, a circular hole having a diameter slightly larger than the outer diameter of the columnar second stud 23 to such an extent that the second stud 23 can be press-fitted. The fourth conductor 7 is formed of a conductive material such as metal.

An upper surface of the body 74 can come into contact with the second contacted surface 22 so as to be electrically connected to the second contacted surface 22. For example, the outer diameter of the body 74 may be slightly smaller than the diameter of the inner peripheral surface 61. For example, the upper surface of the body 74 may be a flat surface. For example, the outer diameter of the body 74 may be slightly smaller than the diameter of the inner peripheral surface 61 to such an extent that the fourth conductor 7 can move along the inner peripheral surface 61. For example, the body 74 may be coaxial with the housing 6. For example, the second fitting portion 71 may be coaxial with and penetrate the body 74.

### (Constitution of Biasing Portion)

The biasing portion 5 can bias the fourth conductor 7 toward the second contacted surface 22. The biasing portion 5 can relay conduction between the third conductor 4 and the fourth conductor 7. The biasing portion 5 includes a coil spring 81.

The coil spring 81 has a first end 82 on the fourth conductor 7 side and a second end 83 on the third conductor 4 side. The first end 82 is electrically connected to the fourth conductor 7 by being fixed in contact with the lower surface of the fourth conductor 7. The second end 83 is electrically connected to the third conductor 4 by being fixed in contact with the upper surface of the third conductor 4. The coil spring 81 is formed of a conductive material such as metal. With such a constitution, the coil spring 81 can relay conduction between the third conductor 4 and the fourth conductor 7. That is, the coil spring 81 can relay conduction between the device conductor 2 and the third conductor 4 via the fourth conductor 7.

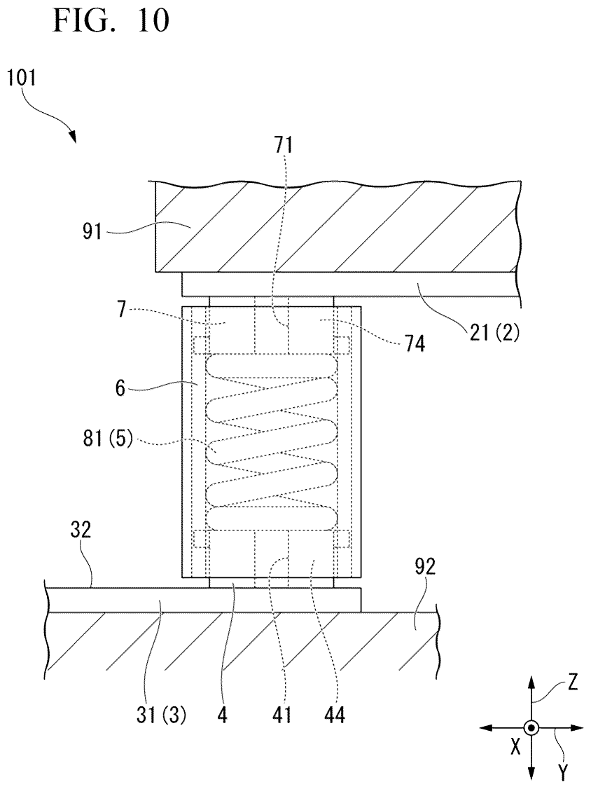

When the assembly 9 is assembled, for example, the device 91 is tightened to be fastened to the battery pack 92 with the fastener 93 such that the device 91 is brought close to the battery pack 92. With such fastening, as illustrated in FIG. 10, the third conductor 4 comes into contact with the first contacted surface 32 while the first stud 33 is fitted into the first fitting portion 41. At the same time, the fourth conductor 7 comes into contact with the second contacted surface 22 while the second stud 23 is fitted into the second fitting portion 71. When further tightened, the third conductor 4 receives a pressing force upward from the first contacted surface 32. In addition, the fourth conductor 7 receives a pressing force downward from the second contacted surface 22.

The third conductor 4 moves in the Z direction with respect to the device conductor 2 and the battery conductor 3, so that the third conductor 4 receiving the pressing force from the first contacted surface 32 elastically deforms the biasing portion 5. On the other hand, the elastically deformed biasing portion 5 exerts a biasing force directed toward the first contacted surface 32 on the third conductor 4. Due to the deformation and the biasing force, in the assembled assembly 9, the third conductor 4 comes into contact with the first contacted surface 32 while the biasing portion 5 absorbs the pressing force from the first contacted surface 32. In addition, the third conductor 4 comes into contact with the first stud 33 in the first fitting portion 41. Further, the biasing portion 5 relays conduction between the third conductor 4 in contact with the battery conductor 3 and the device conductor 2.

Additionally, the fourth conductor 7 moves in the Z direction with respect to the device conductor 2 and the battery conductor 3, so that the fourth conductor 7 receiving the pressing force from the second contacted surface 22 elastically deforms the biasing portion 5. On the other hand, the elastically deformed biasing portion 5 exerts a biasing force directed toward the second contacted surface 22 on the fourth conductor 7. Due to the deformation and the biasing force, in the assembled assembly 9, the fourth conductor 7 comes into contact with the second contacted surface 22 while the biasing portion 5 absorbs the pressing force from the second contacted surface 22. In addition, the fourth conductor 7 comes into contact with the second stud 23 in the second fitting portion 71. Further, the biasing portion 5 relays conduction between the fourth conductor 7 and the third conductor 4 in contact with the device conductor 2.

As a result of these contacts, the connection structure 1 can electrically connect the device conductor 2 and the battery conductor 3.

### Operation and Effect

In the connection structure 101 of the present embodiment, with the constitution of the fourth conductor 7 and the biasing portion 5, the fourth conductor 7 can be brought into contact with the device bus bar 21 while biasing the fourth conductor 7 in the moving direction. The fourth conductor 7 brought into contact in this manner can secure the contact pressure with the device bus bar 21 while changing the position in the moving direction. With such an operation, the connection structure 101 can absorb manufacturing tolerance related to electrical connection between the device conductor 2 and the battery conductor 3, which is likely to occur at the time of assembling the device 91 and the battery pack 92. Therefore, the connection structure 101 of the present embodiment can easily secure the contact pressure between the device conductor 2 and the battery conductor 3.

In addition, according to the present embodiment, the connection structure 101 has effects similar to those of the connection structure 1 of the first embodiment.

### Modification

In an example of the connection structure 101 of the present embodiment, the second fitting portion 71 is configured so that the second stud 23 can be inserted thereinto. Note, however, that the fourth conductor 7 may be configured in any manner as long as the fourth conductor 7 can come into contact with the second stud 23. As a modification, similarly to the modification of the third conductor 4, the fourth conductor 7 may include an elastic conductor to be fitted in a recess provided on the upper surface of the body 74 instead of the second fitting portion 71. According to such an elastic conductor, electrical connectivity between the fourth conductor 7 and the second stud 23 can be improved. In addition, according to such an elastic conductor, the insertion force is reduced as compared with the case where the second stud 23 is press-fitted into the second fitting portion 71.

In an example of the connection structure 101 of the present embodiment, the first end 82 is electrically connected to the fourth conductor 7 by being fixed in contact with the lower surface of the fourth conductor 7. Note, however, that this constitution may be configured in any manner as long as electrical connection can be secured. As a modification, the first end 82 may be molded integrally with the fourth conductor 7.

In an example of the connection structure 101 of the present embodiment, the second end 83 is electrically connected to the third conductor 4 by being fixed in contact with the upper surface of the third conductor 4. Note, however, that this constitution may be configured in any manner as long as electrical connection can be secured. As a modification, the second end 83 may be molded integrally with the third conductor 4.

### Other Modifications

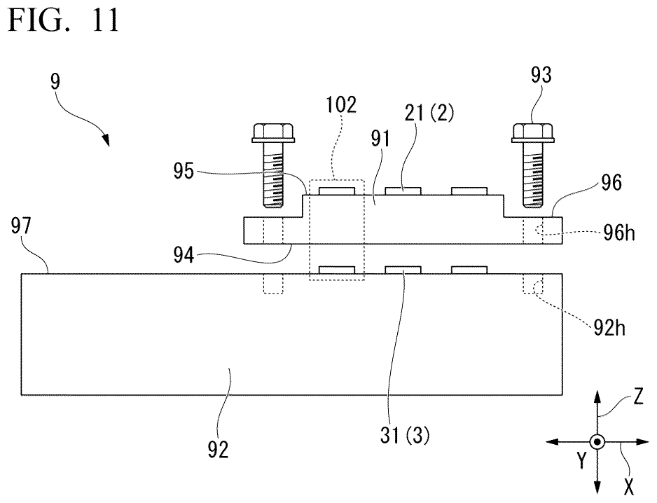

In an example of each of the above-described embodiments, the connection structures 1 and 101 are provided between the second installation surface 94 and the first installation surface 97. The device bus bar 21 is in contact with the second installation surface 94 of the device 91. Note, however, that the connection structures 1 and 101 may be applied to any device bus bar 21 as long as the device 91 and the battery pack 92 can be electrically connected. As a modification, as in a connection structure 102 illustrated in FIG. 11, a device bus bar 21 may come into contact with a main surface 95 of a device 91. In the constitution of such a modification, the connection structure 102 is provided between the main surface 95 and a first installation surface 97. In such a constitution, for example, a housing 6 may be provided so as to penetrate the device 91 from the main surface 95 toward the first installation surface 97.

In the example of each of the above-described embodiments, the second conductor 2 including the second bus bar 21 is connected to the device 91, and the first conductor 3 including the first bus bar 31 is connected to the battery pack 92. However, in the connection structure 1, the device conductor 2 and the battery conductor 3 may be configured in reverse. As a modification, the connection structure 1 may be configured such that the first conductor 3 including the first bus bar 31 is connected to the device 91 and the second conductor 2 including the second bus bar 21 is connected to the battery pack 92.

In the example of each embodiment described above, the biasing portion 5 includes the coil springs 51 and 81. Note, however, that the biasing portion 5 may have any constitution instead of the coil springs 51 and 81 as long as the biasing portion 5 can bias and can relay conduction. As a modification, the biasing portion 5 may include a leaf spring, a disc spring, or the like formed of a conductive material such as metal instead of the coil springs 51 and 81 or in addition to the coil springs 51 and 81. Note that when the distance in the Z direction to be relayed is long, as compared with these modifications, since the example of the above-described embodiment uses the coil springs 51 and 81 having a shape extending in one direction, the biasing portion 5 can be configured with a simpler structure.

While the embodiments of the present disclosure have been described above, the embodiments are shown as examples and are not intended to limit the scope of the present disclosure. This embodiment can be implemented in various other forms, and various omissions, substitutions, and changes can be made without departing from the gist of the present disclosure.

### INDUSTRIAL APPLICABILITY

According to the connection structure and the assembly of the present disclosure, it is easy to secure the contact pressure of a conductor.

### BRIEF DESCRIPTION OF THE REFERENCE SYMBOLS

1 Connection structure
2 Device conductor (second conductor)
3 Battery conductor (first conductor)
4 Third conductor
5 Biasing portion
6 Housing
7 Fourth conductor
9 Assembly
21 Device bus bar (second bus bar)
22 Second contacted surface
23 Second stud
31 Battery bus bar (first bus bar)
32 First contacted surface
33 First stud
41 First fitting portion
42 Elastic conductor
43 Recess
44 Body
45 Protrusion
46 First protrusion
47 Second protrusion
48 Third protrusion
49 Fourth protrusion
51 Coil spring
52 First end
53 Second end
61 Inner peripheral surface
62 Groove
71 Second fitting portion
74 Body
75 Protrusion
81 Coil spring
82 First end
83 Second end
91 Device
92 Battery pack
921 Screw hole
93 Fastener
94 Second installation surface
95 Main surface
96 Flange
96h Through hole
97 First installation surface
101 Connection structure
102 Connection structure
PC Current path

What is claimed is:

1. A connection structure comprising:
a first conductor including a first bus bar, the first bus bar having a first contacted surface and including a first stud protruding from the first contacted surface;
a second conductor provided at a position away from the first conductor;
a third conductor configured to be brought into contact with the first contacted surface and the first stud, the third conductor being movable with respect to the first conductor and the second conductor in a moving direction intersecting the first contacted surface; and
a biasing portion capable of biasing the third conductor toward the first contacted surface and capable of relaying conduction between the second conductor and the third conductor.

2. The connection structure according to claim 1, further comprising
a housing having an inner peripheral surface and accommodating the biasing portion, wherein
the third conductor is movable along the inner peripheral surface.

3. The connection structure according to claim 1, wherein
the biasing portion includes a coil spring having a first end electrically connected to the first conductor and a second end electrically connected to the third conductor.

4. The connection structure according to claim 1, further comprising
a first fitting portion into which the first stud is inserted.

5. The connection structure according to claim 1, further comprising
an elastic conductor configured to come into contact with the first stud.

6. The connection structure according to claim 1, wherein
the second conductor includes a second bus bar, the second bus bar having a second contacted surface and including a second stud protruding from the second contacted surface;
the connection structure further includes a fourth conductor configured to be brought into contact with the second contacted surface and the second stud and movable with respect to the first conductor and the second conductor in the moving direction; and
the biasing portion is capable of biasing the fourth conductor toward the second contacted surface and capable of relaying conduction between the third conductor and the fourth conductor.

7. An assembly comprising:
the connection structure according to claim 1;
a battery pack connected to one of the first conductor and the second conductor; and
a device connected to the other of the first conductor and the second conductor.
